(19) United States
(12) Patent Application Publication
(10) Pub. No.: US 2003/0179265 A1
(43) Pub. Date: Sep. 25, 2003

(54) Reduced movement off-line inking device

(76) Inventors: Scott William Feldhacker, Mesa, AZ (US); Marc Evan Radin, Phoenix, AZ (US)

Correspondence Address: WEISS & MOY PC, 4204 NORTH BROWN AVENUE, SCOTTSDALE, AZ, 85251, US

(21) Appl. No.: 10/107,517

(22) Filed: Mar. 25, 2002

(51) Int. Cl. B41J 2/14

(52) U.S. Cl. 347/49

(57) ABSTRACT

A reduced movement off-line inking device is shown. The reduce movement off-line inking device comprises an interference fit ink cartridge collar; and a substantially immovable ink cartridge support coupled to the interference fit ink cartridge collar; wherein the substantially immovable ink cartridge support comprises: a base member mounted upon a prober ring carrier; and a support arm member mounted to the base member, the support arm member coupled to the substantially immovable ink cartridge support.

### 1. FIELD OF THE INVENTION

This invention is in the field of semiconductor fabrication processing systems, and more particularly, is a device to reduce the movement of an off-line inking device ink cartridge.

### 2. DESCRIPTION OF THE RELATED ART

The present invention concerns an off-line inker which inks failed die on a integrated circuit wafer during the inking operation performed as part of the Electrical Wafer Sort (EWS) processing step that follows the wafer electrical functional test. The process of in-line inking differs from the process of off-line inking in that in-line inking is performed at the same time and on the same piece of equipment, known as a prober, upon which the wafers are electrical functionally tested. In contrast, the off-line inking procedure takes place after the electrical functional test and using a separate piece of equipment, which is also a prober, but is mechanically configured and dedicated as an inker. The off-line inking procedure utilizes a host computer to download electrical functional test maps from the prober to the inker showing the failed die of the wafer, as indicated by the electrical functional test. The inker then inks the failed die based on the electrical functional test maps.

The off-line inking method is preferable to the in-line inking procedure because of inherent drawbacks to the in-line inking method. In the in-line inking method, anytime the electrical test results in a failed die, that die is inked. However, the failed die indication may be due to test problems such as electrical interface damage (probe card damage), tester or prober problems. Regardless of the incorrect electrical identification however, the subject die are rejected or failed. Following correction of the test problem, the die that have been incorrectly identified as failed are therefore scrapped due to having been identified and inked as failed die. Further problems with in-line inking include issues of placement and size of the ink dots, which can lead to further wasted product and lower yields due to scraping of the incorrectly inked die.

Addressing the off-line inking method however, although the off-line inking method is preferable to the in-line inking method, this method is also subject to its own drawbacks. Present models of off-line inker assembles have calibration adjustments in the X, Y, and Z axis'. These adjustments are manual, mechanical, adjustments performed by physical movement and adjustment of the off-line inking assembly atop the ring carrier. Because these adjustments are manual mechanical adjustments, they do not take advantage of the prober's software capabilities for off-line inker assemblies. Furthermore, the mechanical adjustment actually interferes with the prober software capabilities causing a lack of alignment correlation between the software and the off-line inking assembly. This lack of alignment correlation results in a software error of “Operator error” when attempting to utilize the prober software. Therefore, it becomes necessary to disable the automatic Ink dot inspection (IDI) feature in the prober. The IDI is a feature in the prober software and hardware that includes an optics camera to inspect the ink dots for pass or rejection. Additionally, a large source of error exists in the interface between the ink cartridge and the ink cartridge holder. The ink cartridge holder has a split prong arm into which the ink cartridge is snap fitted. This snap fit allows a degree of flexibility and movement of the ink cartridge within the confines of the split prong arm. Furthermore, the structure of the split prong arm allows it be easily deformed due to incorrect handling, even if the applied force is small. This deformation introduces yet another lack of alignment correlation between the software and the off-line inking assembly.

Therefore, a need existed for an off-line inking assembly that would eliminate the possibility of errors arising from manual mechanical adjustments by operators of the off-line inking assembly. An additional need existed for an off-line inking assembly that would eliminate the error introduced by the ink cartridge holder, split prong arm interface to an ink cartridge. Moreover, a further need existed for an off-line inking assembly that by removing the operator induced errors would allow the use of the IDI feature of the prober software.

### SUMMARY OF THE INVENTION

An object of the present invention is to provide an off-line inking assembly that will eliminate the possibility of errors arising from manual mechanical adjustments by operators of the off-line inking assembly. An additional object of the present invention is to provide an off-line inking assembly that will eliminate the error introduced by the ink cartridge holder, split prong arm interface to an ink cartridge. Yet another object of the present invention is to provide an off-line inking assembly that will remove the operator induced errors thus allowing the use of the IDI feature of the prober software.

### BRIEF DESCRIPTION OF THE PREFERRED EMBODIMENTS

In accordance with one embodiment of the present invention, a reduced movement off-line inking device is disclosed. The reduced movement off-line inking device comprises a location arm and an interference fit ink cartridge collar integral to the location arm.

In accordance with yet a further embodiment of the present invention, a reduced movement off-line inking device is disclosed. The reduced movement off-line inking device comprises an interference fit ink cartridge collar; a substantially immovable ink cartridge support coupled to the interference fit ink cartridge collar; and wherein the substantially immovable ink cartridge support comprises: a base member mounted upon a prober ring carrier; and a support arm member mounted to the base member, the support arm member coupled to the substantially immovable ink cartridge support.

### BRIEF DESCRIPTION OF THE DRAWINGS

FIG. 1 shows a side view of a prior art off-line inking assembly with the components and the mechanical adjustments identified.

FIG. 2 shows an exploded side view of a prior art off-line inking assembly.

FIG. 3 shows a top perspective view of the off-line inking assembly of the present invention connected to a ring carrier.

FIG. 4 shows a close up top perspective view of the off-line inking assembly of the present invention connected to a ring carrier in place over a die being inked.

FIG. 5a shows an exploded side view of the off-line inking assembly of the present invention.

FIG. 5b shows a side view of an ink cartridge prior to insertion into the location arm of the present invention.

FIG. 5c shows a side view of an ink cartridge following insertion into the location arm, and prior to removal from the location arm.

FIG. 6a shows a perspective view of a prior art location arm and its snap fit split prong arm.

FIG. 6b shows a perspective view of a location arm and its interference fit ink cartridge collar in a preferred embodiment of the present invention.

FIGS. 6c-d show perspective views of a pneumatic shuttle guide to which the location arm of the prior art, or the location arm in a preferred embodiment of the present invention is inserted into and connected thereto.

### DESCRIPTION OF THE PREFERRED EMBODIMENTS

Prior Art

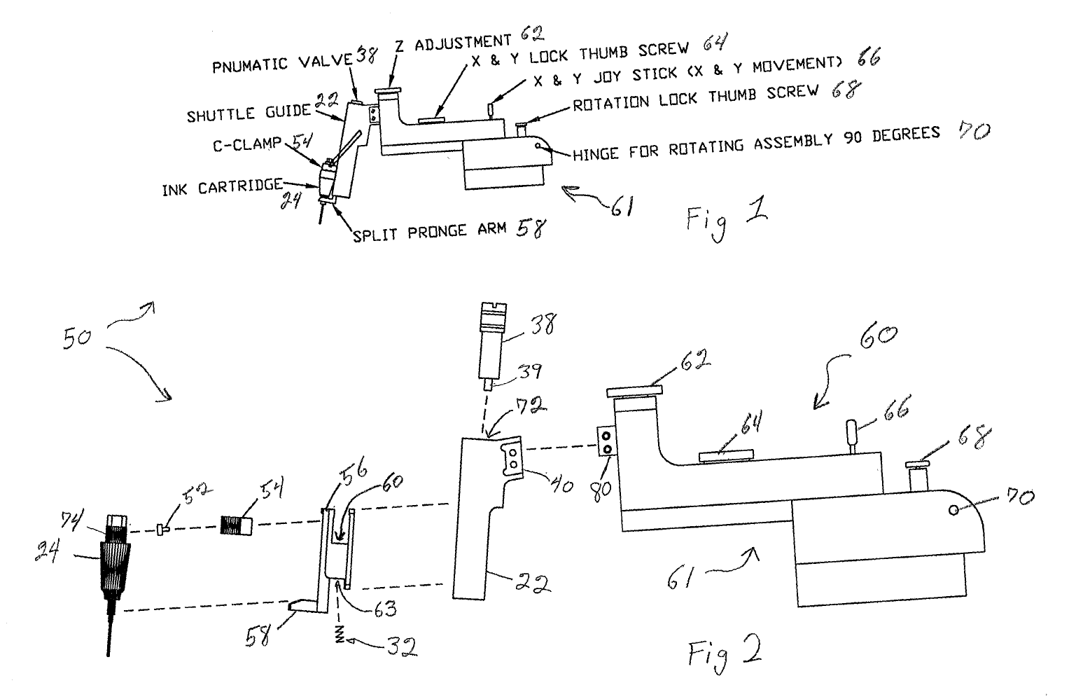

Referring to FIG. 1, a side view of a prior art off-line inking assembly 50 with the components and the mechanical adjustments identified is shown. The prior art comprises an ink cartridge 24 inserted into a snap fit split prong arm 58 that is itself integral to a shuttle guide 22. The ink cartridge 24 is held in place by a c-clamp 54 located at its upper end in combination with the snap fit split prong arm 58. The shuttle guide 22 is coupled to the inking support and adjustment assembly 61. The inking support and adjustment assembly 61 includes adjustments in the X, Y and Z axis comprised of: Z adjustment 62, and X and Y joy stick 66. The X and Y joystick adjustment may be locked by the X and Y lock thumbscrew 64. The inking support and adjustment assembly 61 is further hinged for rotation about a hinge axis 70 to permit raising of the inking support and adjustment assembly 61 from its position over the die (see FIG. 2)

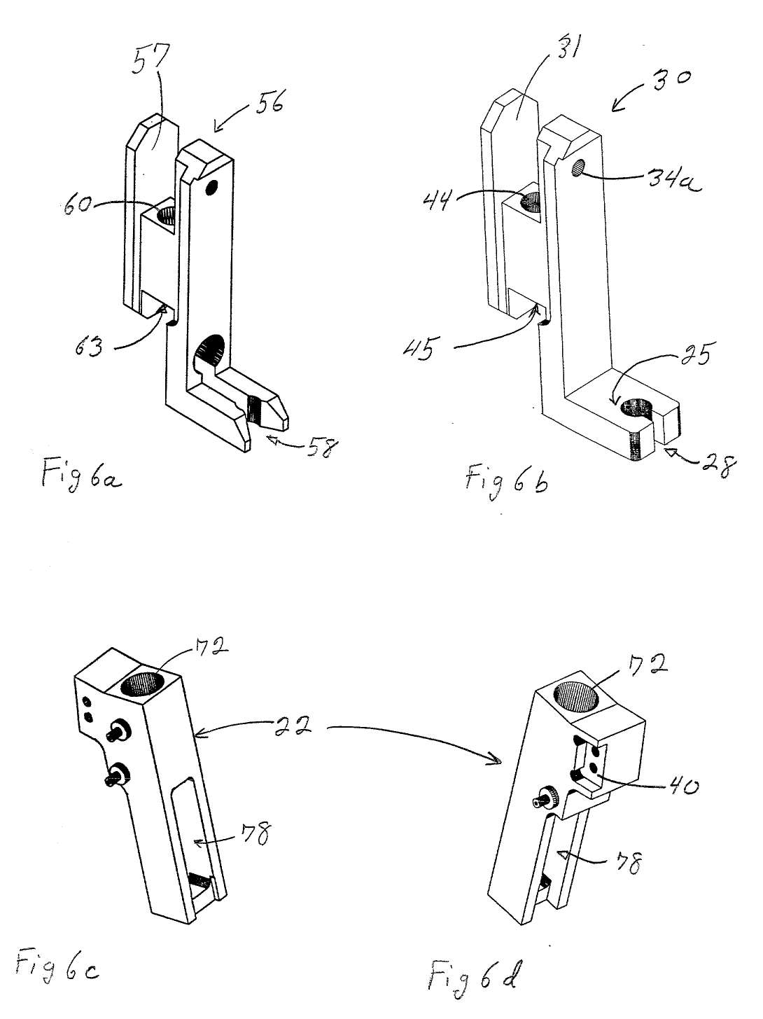

Referring to FIG. 2, an exploded side view of a prior art off-line inking assembly 50 with the components and the mechanical adjustments identified is shown. The location arm 56 has a c-clamp 54 at its upper end connected to it with a screw 52. The ink cartridge 24 is inserted into the snap fit split prong arm 58 at the bottom end of the location arm 56 while simultaneously snapping the ink cartridge c-clamp collar 74 into the c-clamp 54. As previously discussed, the insertion of the ink cartridge 24 into the snap fit split prong arm 58 allows a degree of flexibility and movement of the ink cartridge 24 within the confines of the snap fit split prong arm 58. This flexibility and movement consequently introduces a lack of alignment correlation between the prober software and the off-line inking assembly 50. The location arm 56 couples to the shuttle guide 22 by inserting the body of the location arm 56 into the shuttle guide receiving cavity 78 (see FIGS. 6c, d).

Referring to FIG. 6a, c and d, the insertion and coupling of the location arm 56 into the shuttle guide 22 is shown in more detail. The location arm 56 has a back flange 57, which is inserted into and through the shuttle guide receiving cavity 78. This insertion will have the effect of aligning the centerline of the axis' of the shuttle guide pneumatic valve bore 72 and the location arm pneumatic valve receiving bore 60. These two bores are then filled as the pneumatic valve 38 (see FIG. 2) inserts into the shuttle guide pneumatic valve bore 72 and extends down and through the location arm pneumatic valve receiving bore 60.

Returning to FIG. 2, the lower tip 39 of the pneumatic valve 38 penetrates through the tensioning spring 32, which is located at the bottom end 63 of the location arm pneumatic valve receiving bore 60. The lower tip 39 then screws into a threaded socket (not shown) in the bottom of the shuttle guide 22. The shuttle guide 22 attaches to the inking support and adjustment assembly 61 by means of a shuttle guide coupling key 80 mating with the support arm keyway 40. The mating is secured using standard mechanical fasteners such as nuts and bolts as are well known in the art (not shown herein.)

Preferred Embodiment

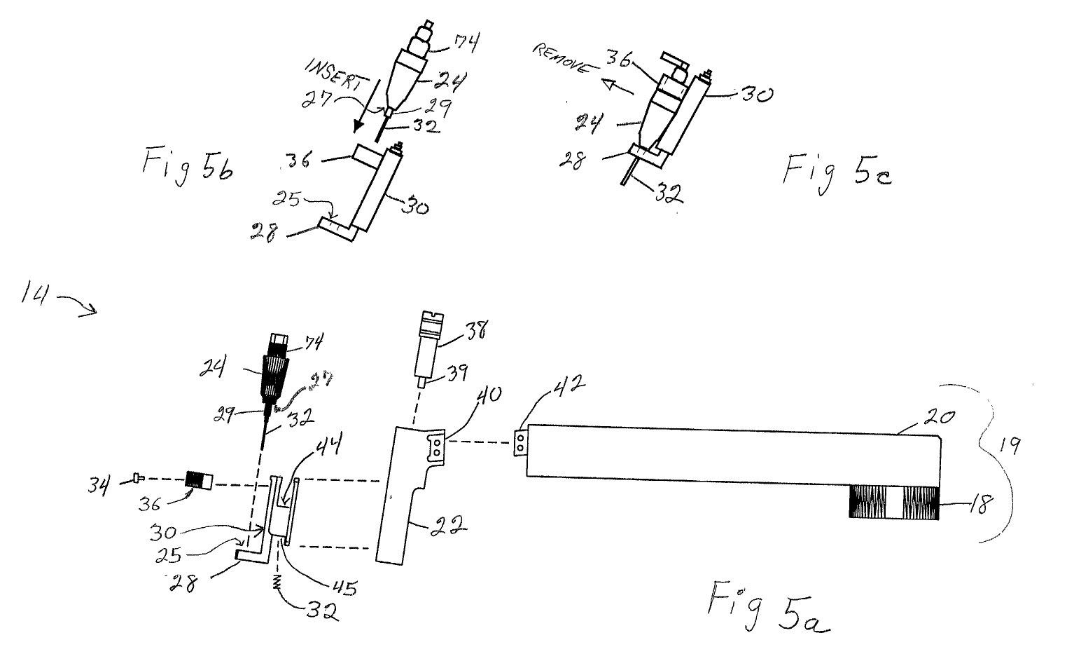

Referring to FIGS. 5a, b and c, an exploded side view of the off-line inking assembly 14 in a preferred embodiment is shown along with side views of an ink cartridge 24 prior to and following insertion into the location arm 30. Referring to FIG. 5a, a preferred embodiment of the present invention comprises a location arm 30 equipped with a c-clamp 36 connected to it with a screw 34. An important feature and difference over the prior art is the insertion of an ink cartridge 24 into the location arm 30. Referring to FIGS. 5b and c, the ink cartridge 24 is inserted in a downward direction such that the ink cartridge needle 32 passes through the centerline axis of the c-clamp 36, into, and through the centerline axis of the interference fit ink cartridge collar 28. The ink cartridge 24 is pushed down until the ink cartridge needle ridge 29, which is tapered, is seated into the interference fit ink cartridge collar 28, the retention lip 27 is mated firmly against the flat mating surface 25 of the interference fit ink cartridge collar 28, and the ink cartridge c-clamp collar 74 is snapped tight into the c-clamp 36. This interference fit of the ink cartridge needle ridge 29 into the interference fit ink cartridge collar 28 restricts movement or misalignment of the ink cartridge 24 within the confines of the interference fit ink cartridge collar 28 thereby contributing to a constant and exact alignment correlation between the prober software and the off-line inking assembly 14.

The removal of the ink cartridge 24 from the location arm 30 is performed by grasping the ink cartridge 24 and pulling the c-clamp collar 74 out of the c-clamp 36. The pulling will result in bending the ink cartridge needle 32 which is constrained by the interference fit between the ink cartridge needle ridge 29 and the interference fit ink cartridge collar 28. The ink cartridge 24 is then fully removed by lifting vertically to remove the ink cartridge needle ridge 29 from the interference fit ink cartridge collar 28.

Referring again to FIG. 5a, it can be seen that the location arm 30 couples to the shuttle guide 22 by inserting the body of the location arm 30 into the shuttle guide receiving cavity 78. This may be seen in more detail in FIGS. 6b, c and d. It may be observed that the shuttle guide 22 is the same as in the prior art. This feature allows the reuse of a component, i.e. the shuttle guide 22, already possessed by the user of a prober inker system. The location arm 30 has a back flange 31, which is inserted into and through the shuttle guide receiving cavity 78. This insertion will have the effect of aligning the centerline of the axis' of the shuttle guide pneumatic valve bore 72 and the location arm pneumatic valve receiving bore 44. These two bores are then filled as the pneumatic valve 38 (See FIG. 5a) inserts into the shuttle guide pneumatic valve bore 72 and extends down and through the location arm pneumatic valve receiving bore 44.

Referring back to FIG. 5a, the lower tip 39 of the pneumatic valve 38 penetrates through the tensioning spring which is located at the bottom end 45 of the location arm pneumatic valve receiving bore 44. The lower tip 39 then screws into a threaded socket (not shown) in the bottom of the shuttle guide 22. The shuttle guide 22 attaches to the inking support assembly 19 by means of a shuttle guide coupling key 42 mating with the support arm keyway 40. The mating is secured using standard mechanical fasteners such as nuts and bolts as are well known in the art (not shown herein.)

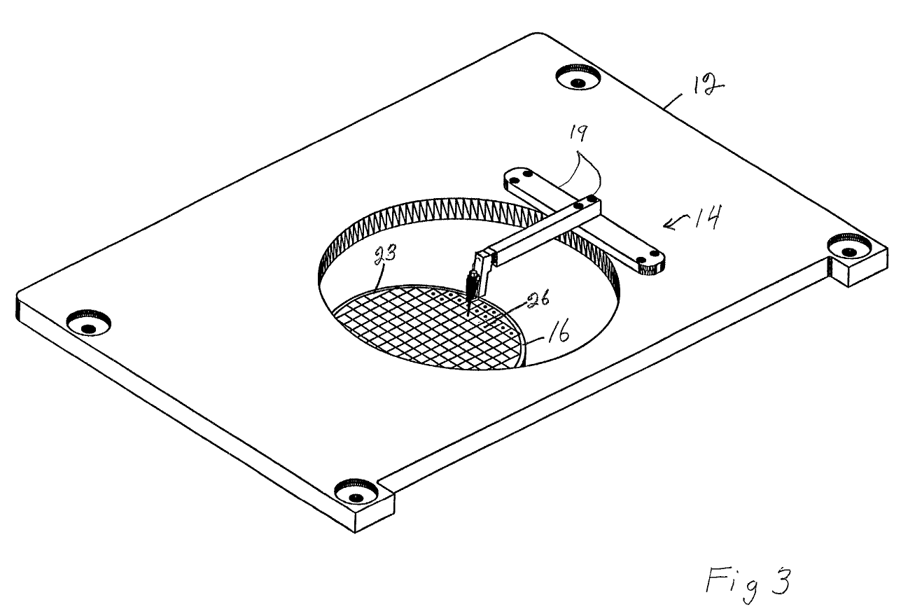

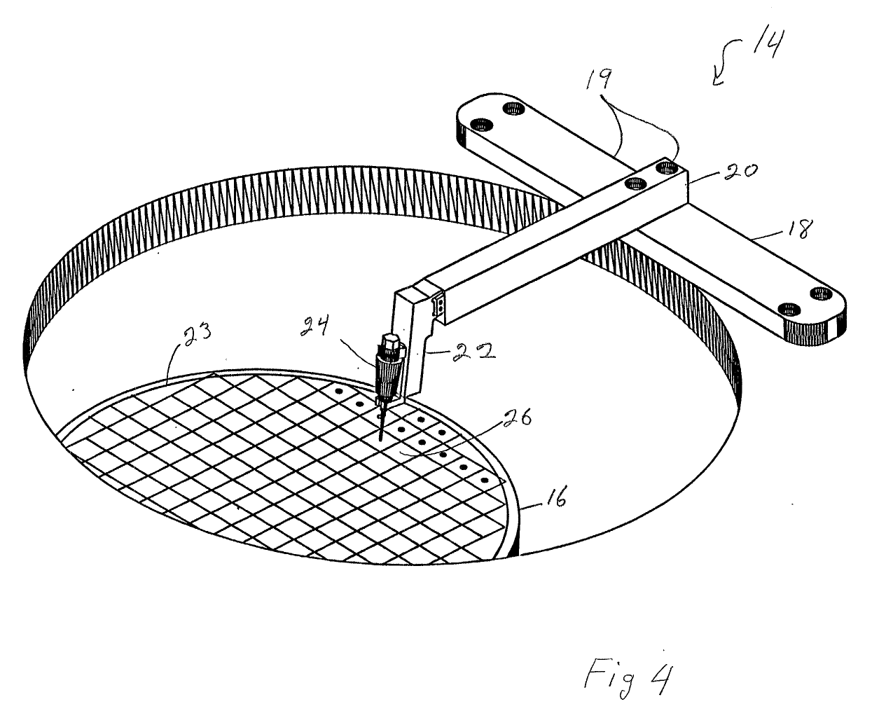

Referring to FIG. 4, a close up top perspective view of the off-line inking assembly 14 connected to a ring carrier (not explicitly shown herein) in place over a die 26 upon a wafer 23 being inked is shown. The off-line inking assembly 14 comprises the inking support assembly 19 to which the shuttle guide 22 is connected. The inking support assembly 19 consists of a support arm 20 connected to a base member 18. The connection between the support arm 20 and the base member 18, in a preferred embodiment, is performed using standard mechanical fasteners such as nuts and bolts as are well known in the art (not shown herein). However, those skilled in the art will recognize that what is embodied herein as a two piece assembly for a preferred embodiment may also be machined or produced as a single piece assembly in an alternate embodiment. The base member 18 is secured to the ring carrier 12 (see FIG. 3) to complete the embodiment. The inking support assembly 19 is an important feature in a preferred embodiment of the present invention because, having no X, Y or Z adjustments, operators cannot move the support arm 19 from its installed position. This lack of movement of the support arm 19 contributes to a constant and exact alignment correlation between the prober software and the off-line inking assembly 14. This in turn allows the use of the automatic Ink Dot Inspection (IDI) feature in the prober.

The combination of the interference fit ink cartridge collar 28 and the support arm 19 eliminates the X, Y and Z axis variables that existed in the prior art. The alignment variables are now reduced to the ink dot size and duration control, which is set once and then locked by a nonadjustable bracket (not shown herein.) Thus, the only adjustment variable is the Z height of the prober's chuck 16 (see FIGS. 3 and 4) which is controlled to 0.1 mil or 0.0001 inch (not shown herein). Because the operator must now use the prober's software to set the X, Y and Z position of the ink dots (not shown herein), this guarantees that the ink dots will be in the correct location, at the center of a failed die, and of the correct size. This reduces the scrap caused by the problems of miss-located and/or incorrect size ink dots, mask shift corrections, etc.

Although the invention has been particularly shown and described with reference to a preferred embodiment thereof, it will be understood by those skilled in the art that changes in form and detail may be made therein without departing from the spirit and scope of the invention.

What is claimed is:

1. A reduced movement off-line inking device, comprising, in combination:
a location arm; and
an interference fit ink cartridge collar integral to said location arm.

2. The reduced movement off-line inking device of claim 1 further comprising a location arm having said interference fit ink cartridge collar integral thereto at a first end.

3. The reduced movement off-line inking device of claim 2 further comprising a spring clip attached to said location arm at a second end opposite from said interference fit ink cartridge collar at said first end.

4. The reduced movement off-line inking device of claim 3 wherein said location arm further comprises a pneumatic valve receiving bore substantially concentric to said location arm and parallel to an axis aligned substantially concentrically through said spring clip and said interference fit ink cartridge collar.

5. A reduced movement off-line inking device, comprising, in combination:
an interference fit ink cartridge collar;
a substantially immovable ink cartridge support coupled to said interference fit ink cartridge collar; and
wherein said substantially immovable ink cartridge support comprises:
a base member mounted upon a prober ring carrier; and
a support arm member mounted to said base member, said support arm member coupled to said substantially immovable ink cartridge support.

6. The reduced movement off-line inking device of claim 5 further comprising a location arm having said interference fit ink cartridge collar integral thereto at a first end.

7. The reduced movement off-line inking device of claim 6 further comprising a spring clip attached to said location arm at a second end opposite from said interference fit ink cartridge collar at said first end.

8. The reduced movement off-line inking device of claim 7 wherein said location arm further comprises a pneumatic valve receiving bore substantially concentric to said location arm and parallel to an axis aligned substantially concentrically through said spring clip and said interference fit ink cartridge collar.
